(19) United States
(12) Patent Application Publication
(10) Pub. No.: US 2015/0285426 A1
(43) Pub. Date: Oct. 8, 2015

(54) SINGLE LAYER FIRE BARRIER WRAP FOR GREASE DUCTS

(71) Applicant: Alan Shaw, Lockport, NY (US)

(72) Inventor: Alan Shaw, Lockport, NY (US)

(21) Appl. No.: 14/674,275

(22) Filed: Mar. 31, 2015

Related U.S. Application Data
(60) Provisional application No. 61/974,014, filed on Apr. 2, 2014.

(51) Int. Cl. F16L 59/14; B32B 5/02; B32B 15/14; F16L 57/04

(52) U.S. Cl. CPC F16L 59/145; F16L 57/04; B32B 5/02; B32B 15/14; B32B 2250/40; B32B 2262/108; B32B 2307/3065; B32B 2571/00

(57) ABSTRACT

A five sheet single-layer duct wrap consists of two sheets of fiber-insulation-blanket, one on each side of an aluminum or stainless steel foil sheet completely encased by a three-ply laminate sheet comprising an outer-most aluminum foil backing ply, followed by a fiberglass scrim ply, and then a ply of aluminized polyester face. The laminate sheet provides a top and bottom sheet in a cross-sectional view. A seven sheet wrap consists of a protective cloth central sheet or an intumescent mat sandwiched between two sheets of aluminum or stainless steel foil sandwiched between sheets of fiber insulation-blanket having a three-ply laminate completely covering the five sheets. Steel banding secures the wrap to the duct providing 1-3 hours tested and rated protection. One layer cuts installation time and cost by 50% and provides zero clearance to combustible material. The single-layer wrap total thickness is about 1-2 inches.

### CROSS-REFERENCE TO RELATED APPLICATIONS

This is a Non-Provisional Application of Provisional Application No. 61/974,014 filed on Apr. 2, 2014.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to fire-rated duct-wrap systems and, more particularly, to single-layer fire-rated insulating duct-wraps for grease-ducts.

The background information discussed below is presented to better illustrate the novelty and usefulness of the present invention. This background information is not admitted prior art.

A grease duct is a duct that is specifically designed to vent grease-laden vapors from commercial cooking equipment such as, stoves, pizza ovens, deep fryers, and woks to the outside of a building or mobile food preparation trailer. Grease ducts are regulated both in terms of their construction and maintenance, forming part of the building's passive fire protection system. Even the cleaning schedule is typically dictated by the fire code and evidence of compliance must be kept on file by the owner. This is due, in part, to the face that grease, during cooking, is heated to the point that it is carried up through the ducts as grease vapors. As the vapors travel through the ducts they are cooled, which causes the grease to precipitate and settle on the colder duct work. This creates a serious safety concern because grease is highly flammable. In fact, grease qualifies as a hydrocarbon due to its inherent chemistry, and regardless of what state it is in, vapor, liquid or solid, it ignites easily and burns very rapidly, necessitating special provisions to accomplish a fire-resistance rating based on an internal grease fire as well as an external fire. The conventional rectangular shape of the grease ducts creates an increased fire hazard, because grease accumulates in the corners. Grease also can “hide” in the pores of carbon steel. Accordingly, grease ducts should be kept as short as possible to minimize grease build-up and they should be wrapped in a tested and rated fire-barrier.

Typically, conventional grease ducts are made of carbon steel, fabricated, and welded into a rectangular shape. A duct system that has its own inherent fire-resistance rating or a metallic duct, either field fabricated or UL certified factory-built are used. Field fabricated is typically made from 16 gauge carbon steel, all welded, per local codes, which is then externally treated with fireproofing. Factory-built designs are UL tested to the UL 1978 test standard and are made from lighter gauge stainless steel and offered in single wall and multiple double wall insulated designs.

Conventional grease ducts usually require an 18-in. clearance separating the grease duct from combustible materials. In many cases, either a ventilated, fire-rated enclosure or a fire-rated insulation wrap system is required to be placed around the duct. Typical materials used for fireproofing field fabricated designs are ceramic fiber, rockwool, calcium silicate, vermiculite boards pressed and bonded with sodium silicate, intumescents, and endothermic materials, sometimes on their own, sometimes in combination with ceramic fiber material.

Despite the regulations that are in effect, commercial kitchen fires continue to cause about $100 million annually in property damage, with cooking and heating activities being the primary culprits. There were 7,100 restaurant fires in 2002, the latest year available, according to the National Fire Data Center of the U.S. Fire Administration. These fires resulted in 108 injuries and $116 million in property loss. Add to that, lost revenue, lost productivity, cost of emergency services, and the disruption of lives and businesses. Cooking oil and grease were the materials that were most frequently first ignited, the report said.

The fire dangers posed by grease ductwork are exemplified by a fire that occurred in the kitchen of the Tropicana Casino Hotel on Mar. 31, 1999. The first report of the fire believed that the fire was on the fourth-floor roof of the Tropicana Hotel as there were flames shooting high into the air. The Tropicana Casino Hotel is a fully protected property with automatic sprinkler systems, an automatic fire alarm, and kitchen range-hood fire suppression systems. The fire caused extensive damage to the kitchen in excess of $350,000. The fire began in the Seaside kitchen in an unattended cooking wok full of vegetable oil. The oil heated to its ignition temperature causing flames to spread vertically to the hood plenum and grease filters. The hotel had recently replaced the filters with non-Underwriters Laboratory (UL)-listed grease filters. They were listed for non-grease-laden cooking vapor application. The fire easily penetrated the filter and proceeded up the exhaust duct to the roof two floors above. The fire moved so quickly that it didn't provide sufficient heat to activate the fire suppression system as its fusible link was located just past the duct collar outlet. The fire extended into the greasy duct and traveled up to the fan housing on the fourth-floor roof. The fire suppression system finally operated when firemen placed a hose line in the roof fan, driving a burst of heat back down at the fusible link. But, when the heat released the fusible link, the system nozzle above the wok still did not operate because it was so heavily covered with oil and grease. The above example points out the importance of the proper use of fire-rated grease-duct wrap.

### SUMMARY

The present Inventor conceived an inventive concept of a fire-tested and fire-rated insulation duct-wrap that is simpler, less time consuming, and less-costly to manufacture and install. He then devised the inventive principles required to construct such a duct-wrap. Thus, the present invention is directed towards how to make and how to use a duct-wrap according to the present inventive principles. The duct-wrap so produced provides the tested and rated fire-protection required using only a single layer of the fire-wrap whereas the many varieties of grease-duct wrap on the market today, all require two layers.

A wrap of the present invention consists of five or seven sheets of various materials. An inner-series or sequence of stacked sheets is completely encased by a three-ply laminate outer-layer sheet. The inner, completely encased sheets are disposed in a mirror-image assembly consisting of two sheets of fiber-insulation-blanket, one on each side of a sheet of aluminum or stainless steel foil. The encasing laminate sheet thus provides a top sheet and a bottom sheet in a cross-sectional view. Thus the three-ply laminate will be both the outer-most sheet and also is the sheet that is in direct contact with the duct that is wrapped. The three-ply laminate sheet comprises aluminum foil backing ply that is the outer-most ply, followed by a fiberglass scrim ply, and then a ply of aluminized polyester face.

If required, or desired, the duct-wrap of the present invention consists of seven sheets. As in the three-sheet duct-wrap, what will be the outermost sheet once the wrap is manufactured ready for installation about a duct is a three-ply laminate comprising aluminum foil backing that is to be the outer-most ply, followed by a fiberglass scrim ply, and then a ply of aluminized polyester face. This three-ply laminate is wrapped about and completely covers the inner-stack of sheets that comprises a sheet of fiber insulation-blanket, followed by a sheet of aluminum or stainless steel foil, underlain by either a sheet of protective cloth, such as what is known in the trade as Z600 or an intumescent mat, and following the mirror-image construction is another sheet of aluminum or stainless steel foil, followed by another sheet of fiber insulation-blanket.

Whether the duct-wrap is made using three sheets of different materials per layer or four sheets of different materials per layer, only a single complete layer is needed to protect a duct. A roll of wrap is supplied in a pre-determined width. Many ducts can be longer than the width. When this occurs, several segments of wrap must be used resulting in the formation of seams where one segment of wrap is installed to abut or to overlap another segment. Each seam created by abutting or by overlap must be secured so that the seam area provides the same protection as the non-seam areas. This is accomplished in several ways. One way is to tightly secure the overlap to the duct using, for example, steel banding. Another way to secure a seam is to overlay a piece of wrap, sized for such use, about the seam and tightly secure the overlaid section of wrap to the underlying wrap.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended, the invention will now be described, by way of example, with reference to the accompanying drawings, wherein like reference characters indicate like parts throughout the several figures, and in which:

FIG. 1 is a perspective view of a roll of an exemplar single-layer fire-rated duct-wrap for grease-ducts.

FIG. 2 is a cross-section view of a five sheet single-layer duct-wrap.

FIG. 3 is a cross-sectional view of a seven sheet single-layer duct-wrap.

FIG. 4 is a cross-sectional view of a grease duct wrapped in duct-wrap sections having overlapping end joins.

FIG. 5 is a cross-sectional view of a grease duct wrapped in duct-wrap sections having butt joins secured by a collar.

FIG. 6 is a perspective view of a grease duct wrapped in duct-wrap sections having an overlapping ends join.

FIG. 7 is a perspective view of a grease duct wrapped in duct-wrap sections having a collared butt-end join.

### REFERENCE CHARACTERS AND PARTS TO WHICH THEY REFER

10 A roll of duct wrap of the present invention.

12 Foil-faced paper laminate sheet.

14 Aluminum or stainless steel foil sheet.

16 Insulation-blanket sheet.

18 An optional layer.

22 Fiberglass scrim laminae.

24 Aluminized polyester face laminae.

26 Aluminum-foil backing laminae.

32 Steel banding.

34 Aluminum-foil tape.

36 Collar for attaching butting edges.

38 Abutting join seam.

40 Overlap.

46 Collar.

100 Duct.

It should be understood that the drawings are not necessarily to scale. In certain instances, details which are not necessary for an understanding of the present invention or which render other details difficult to perceive may have been omitted.

### DEFINITIONS

Encase, as used herein, means to surround entirely.

Intumescent as used herein refers to those materials having properties that cause them to expand (or intumesce) to several times their original size when activated by high temperatures to prevent the spread of flames and smoke to other parts of a building, for example passive fire-seals contain intumescent compounds. The intumescent occurs in many forms and may be, for example an intumescent layer, strip, or paste, such as a caulking material.

Insulation-blanket, as used herein, refers to any number of insulation materials, including high-temperature and fire resistant fiber blankets made from alumina, zirconia, and silica spun ceramic fibers, fiberglass, and the like.

Protective cloth, as used herein, refers to a flexible, strong, protective, fire-resistant material that is designed to mechanically support the insulation material and to protect the insulation material from mechanical damage, as the insulation is mechanically weak and can be easily damaged by tearing or ripping either accidentally or intentionally during or after installation thus largely compromising the integrity of the fire resistant barrier. The fire resistant layers, such as a layer of insulation material together with a layer of intumescent material, can freely move with respect to the one or more protective layers or they may be attached together via threads or other attaching means. Protective cloths may be manufactured from continuous filament amorphous silica yarns, polymeric material, fiber reinforced polymeric material, high-temperature resistant woven textiles, or a metalized, fiberglass cloth, among others. Metalized cloth may include fibers of stainless steel, aluminum, or copper, for example. Protective cloths also include cloths that are woven to provide for shear, including lateral, motion.

UL (Underwriters Laboratories) is an American worldwide safety consulting and certification company headquartered in Northbrook, Ill. It maintains offices in 46 countries. UL was established in 1894 and has participated in the safety analysis of many of the last century's new technologies, most notably the public adoption of electricity and the drafting of safety standards for electrical devices and components. UL provides safety-related certification, validation, testing, inspection, auditing, advising and training services to a wide range of clients, including manufacturers, retailers, policymakers, regulators, service companies, and consumers. UL is one of several companies approved to perform safety testing by the US federal agency Occupational Safety and Health Administration (OSHA). OSHA maintains a list of approved testing laboratories, which are known as Nationally Recognized Testing Laboratories.

Wrap, as used herein, means to wind, fold, or bind around an object as to cover it for protection.

Zero Clearance to Combustibles means that an item, such as an insulated grease duct, can be placed directly or almost directly against combustible materials like wood, walls, or paneling, which eliminates the need for a buffer zone and allows the duct work to fit into much smaller spaces allowing for a variety of placement/design options.

### DETAILED DESCRIPTION

To provide an understanding of the basic structure of the grease-duct wraps made according to the inventive concepts and principles of the present invention, we refer now to the drawings. It should be noted that the disclosed invention is disposed to versions in various sizes, such as lengths and widths to accommodate the variety of sizes of grease-ducts, in addition to variations in shape, content, number and composition of the layer's sheets, and attachment means. Therefore, the versions described herein are provided with the understanding that the present disclosure is intended as illustrative and is not intended to limit the invention to the versions described.

Grease-duct wrap must be manufactured to pass all required fire-rating tests. Additionally, it is desired for the wrap to be manufactured in a time and cost effective manner, as well as being easy and quick to install. The present inventor envisioned a combination of materials and a method of arranging the materials that provide for a grease-duct wrapping that meets the required safety standards, needs less installation space, and is manufactured in a cost and time effective manner. His inventive concept and the following inventive principles provide for the manufacture of a highly-flexible, non-asbestos, fire-resistant grease-duct wrap consisting of at least one sheet of metal foil sandwiched between at least two sheets of inorganic fiber blanket and encapsulated with a scrim-reinforced foil that provides for a thin-profile, high strength, signal-layer wrap providing for zero clearance to combustible and provides a one, two, or three hour fire-resistant rating, all in a single layer instead of the two layers that are currently available. Zero tolerance to combustible is of utmost importance as there is usually on a 3 inch gap between the grease-duct and the combustible wooden trusses of the building. The need for only one layer of wrap according to the present invention, as compared to the two layers required for presently available grease-duct wraps cuts installation time by 50 percent, thus providing the highest quality of fire protection insulation at one-half of the installation cost.

Accordingly, the present invention consists of a single-layer duct wrap, that comprises a sequence of sheets comprising a metal foil sheet sandwiched between two fiber insulation-blanket sheets with a three-ply laminate sheet completely encasing the sequence of sheets forming a single-layer duct wrap. The laminate sheet comprises a three-ply laminate sheet of where the three plys are an aluminum foil backing ply; a fiberglass scrim ply, and an aluminized polyester face ply, with the fiberglass scrim ply located between said aluminum foil backing ply and said aluminized polyester face ply. The metal foil sheet is the example illustrated comprises an aluminum sheet or stainless steel foil sheet.

The inventive concept also contemplates a single-layer duct wrap where the sequence of sheets comprises an additional aluminum or stainless steel foil sheet, and a protective cloth or an intumescent mat sheet, where, in this example, the protective cloth or intumescent mat sheet is sandwiched between the two aluminum or stainless steel foil sheets forming an inner-sheet sequence that is sandwiched between the two fiber insulation-blanket sheets with the laminate sheet completely encasing and sealing the sequence of sheets within itself using metal foil tape forming a single-layer duct wrap.

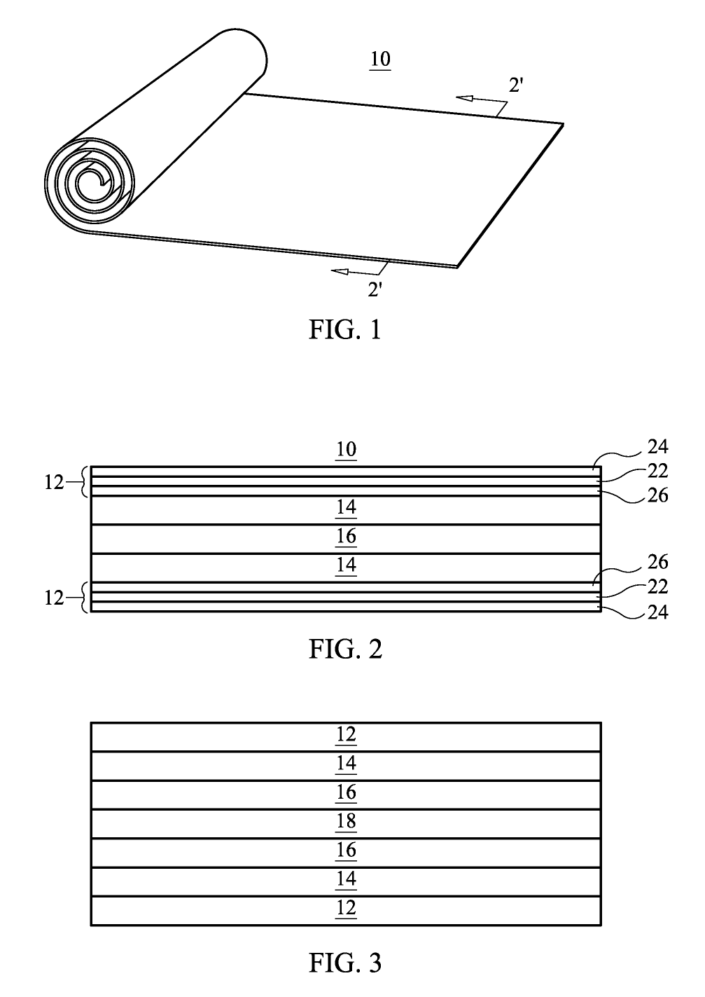

For example, a single-layer duct wrap 10, a roll of which is illustrated in FIG. 1, comprises at least five sheets of material. FIG. 2, a cross-section view of the wrap shown in FIG. 1, illustrates a five-sheet, single-layer wrap. Five sheet single-layer duct wrap 10 comprises an inner stack of three sheets wrapped in and fully covered by a sheet of three ply foil-faced paper 12. The inner stack of three sheets comprises a sheet of fiber insulation-blanket 16, followed by a sheet of aluminum or stainless steel foil 14, followed by another layer of fiber insulation-blanket 16. The inner stack is securely wrapped in the sheet of three ply foil-faced scrim paper 12. The scrim paper 12 once wrapped about the inner stack or sequence of sheets is secured in place using foil tape. At this point the wrap is ready for use. Because the three-ply laminate foil-faced paper 12 completely encloses the inner stack of sheets, it is both the outer most sheet and the sheet that is in contact with the outer surface of the duct that is wrapped in the single-layer wrap. The three ply foil-faced paper 12 consists of a ply of an aluminized polyester face 24 followed by a ply of fiberglass scrim 22, and a ply of aluminum foil backing 26.

Examples of the materials that can be used in the construction of three-ply laminate foil-faced paper 12 include Style 4348 AMA 3/10 mil fiberglass 4×3 scrim adhered with a fire retardant thermo-setting adhesive to an aluminized ½ mil polyester face with an 1 mil aluminum foil backing manufactured by Alpha Alaflex Associates Inc., Lakewood, N.J. 08701. In the example illustrated, 0.004 inch aluminum or stainless steel foil 14 that underlies the three-ply laminate is between 0.001-0.003 inches thick, such as that manufactured by Comet Metals; Solon, Ohio; or equivalent. An example of the material that may be used as fiber-insulation-blanket 16 is a 1/2 inch fire insulation-blanket manufactured using calcium magnesium silicate fiber/amorphous calcium, magnesium, silicate (alkaline-earth-silicate greater than 18%) fiber that is soluble in body fluids/or equal. Such a blanket may be purchased as CMS Fiber Product made from a long, spun fiber yielding excellent thermal conductivity and stability and are manufactured in an ISO 9001-2000 and ISO 14001-1996 Quality Control System. Another material that is contemplated is a spun ceramic fire blanket, such as the DuraBlanket that is an eight pound ceramic spun fiber manufactured by Unifrax Corp; Tonawanda, N.Y. In addition to these two examples any other blanket that will function as required, which may include mineral wool, or super mineral wool, is also contemplated. Protective cloth may include ½ inch thick Z 600 plus cloth manufactured by Newtex; Rochester, N.Y.

If desired, as illustrated in FIG. 3, within the covering sheet of foil-faced paper 12 the inner stack is contemplated to comprise a sheet of fiber insulation-blanket 14, followed by a sheet of aluminum or stainless steel foil 16, underlain by either a high-temperature protective cloth or a intumescent mat, which in followed by another sheet of aluminum or stainless steel foil 16, that is underlain by a sheet of fiber insulation-blanket 14. The Z 600 plus protective cloth 18 used in the illustrated example is manufactured by Newtex of Rochester, N.Y.; equivalent protective blankets are also contemplated. In either the five sheet one layer wrap or a seven sheet one layer wrap the total thickness of the single-layer fire-rated insulation wrap for grease-ducts according to the principles of the present invention is about 1-2 inches. The single layer wraps made according to the principles of the present invention are available in 1, 2, or 3 hour ratings. The number of sheets required by each single layer wrap is dictated by the desired rating. The steel banding 32 is typically placed at six inches on center to secure an installed single layer wrap. Alternatively a wing seal is used to secure the wrap to a duct. It should be understood that any securing means that performs the desired function may be used.

Rolls of wrap are supplied in pre-determined widths. Many ducts requiring wrap are longer than the width of the specific wrap used. Thus, several segments of wrap must be used to wrap an entire length of duct. The space between two segments of wrap must be secured ensuring that this seam area provides the same fire-rated protection as the non-seam areas. The space or seam created is either a wide space of from a few to several inches when the two sections of wrap are spaced apart or a very narrow seam when the two sections of wrap abut each other.

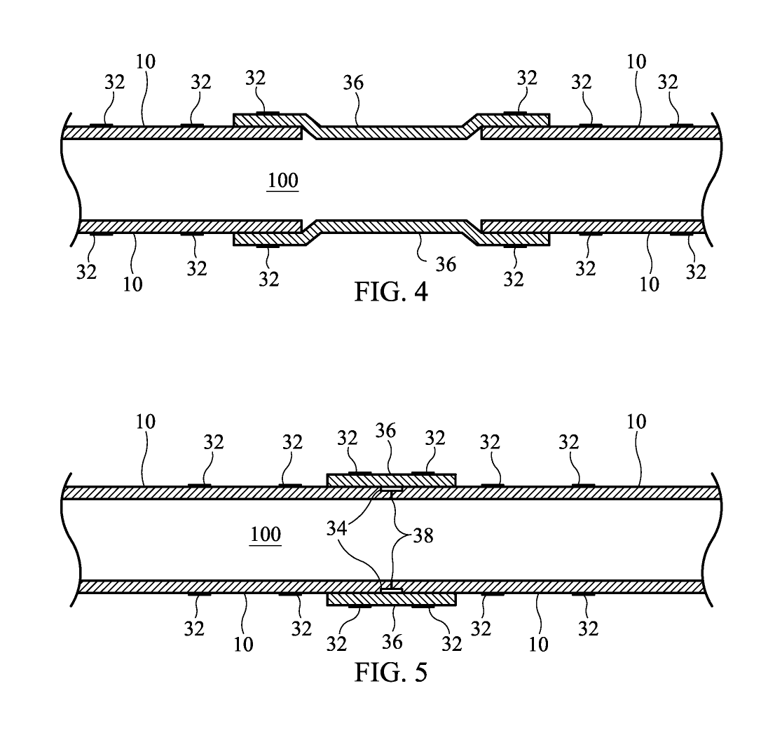

To comply with various installation considerations, two sections of wrap installed about the same duct 100 may be spaced apart, as illustrated in FIG. 4, where the width of the space is from about a few inches to several inches. To secure this space, a section of wrap 36 cut to a required width is installed over the duct in the space between the two spaced-apart sections of wrap 10. The width of wrap 36 is cut about six inches wider than the space between the two sections 10 to provide for each end of wrap section 36 to overlap the corresponding ends of the two wrap sections 10 by approximately three inches. The section 36 overlaps are secured to the two sections 10 using steel banding 32, which in this example is ½ inch wide.

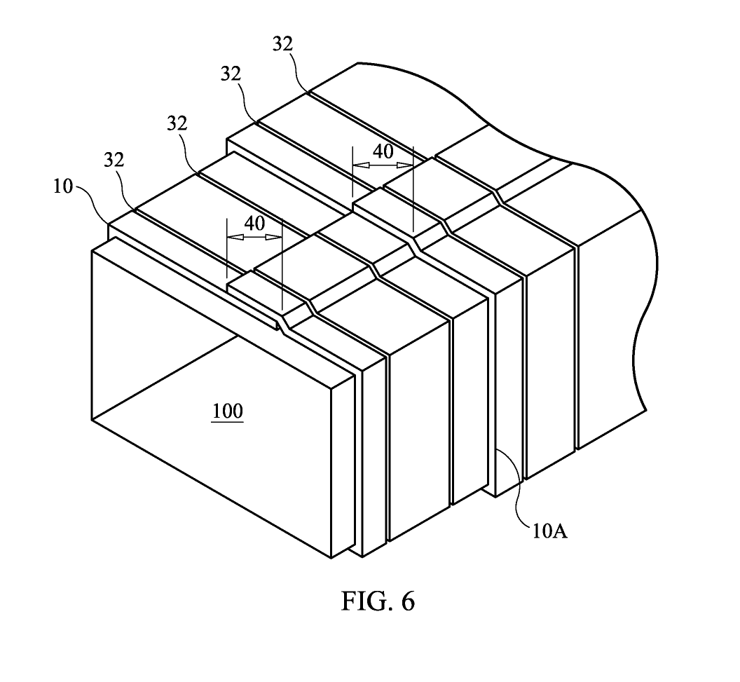

In the case where two lengths of wrap 10 butt up against each other, a seam, such as seam 38 is created, as illustrated in FIG. 5. Seam 38 must be secured to provide the same fire-rated protection as the non-seam areas. Securement is accomplished by first sealing seam 38 with a strip of aluminum foil tape 34, generally available in 3 and 4 inch widths, and then positioning a section of wrap 36 pre-cup to size, commonly referred to as a “single layer collar,” over seam 38 and over the butting ends of the two sections of wrap 10. Generally the collar provides a six-inch overlap. Steel banding 32 is used to tightly secure section of wrap 36 to taped seam 38 and to the immediately adjacent ends of wrap sections 10 and further to secure sections of wrap 10 to the duct.

In the event the edges of insulation-blanket 16 are exposed due to cutting or trimming the wrap, for example, aluminum foil tape 34 is used to cover the exposed blanket fibers. It should be understood that besides aluminum foil tape 34 any tape that provides the required function is contemplated. An example of an aluminum foil tape used in the present invention is thermo-tape manufactured by Intertape Polymer Group; Columbia, S.C., or equivalent

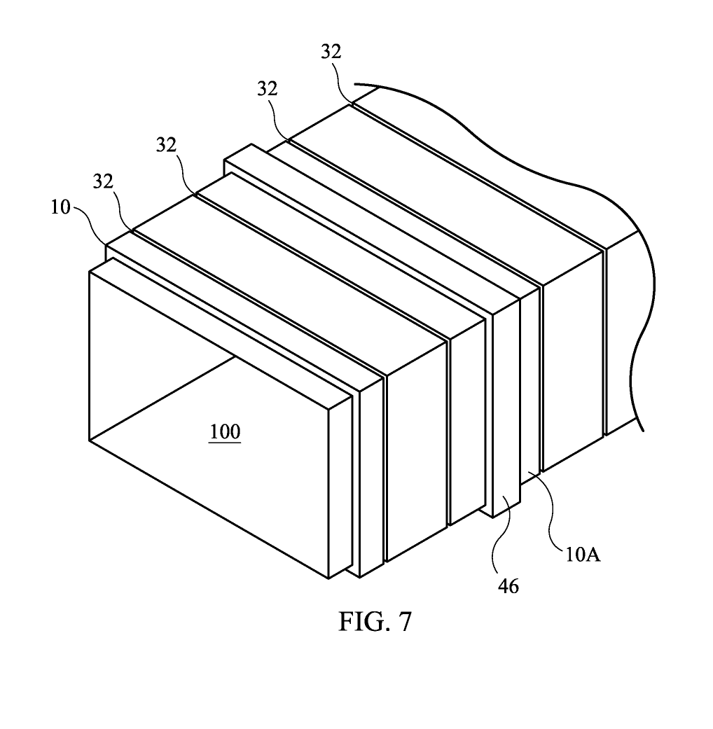

FIG. 6 illustrates grease-duct 100 wrapped with single layer wrap sections 10 and 10A. To insure complete fire-proof protection about the grease-duct, overlapping segment 40 of wrap section 10A overlaps section 10 by at least three inches. The sections are secured to each other and to duct 100 using steel banding 32 that is wrapped completely about the wrapped duct 100 every 6″ on center to assure that the duct is completely insulated with a one-layer, one-three hour tested and rated wrap.

FIG. 7 illustrates wrap section 10A and wrap section 10 installed about duck 100 with wrap section 10A with adjacent end sections 10 and 10A butting up against each other forming a seam as illustrated in FIG. 5. The abutting edges forming the seam are first sealed using aluminum foil tape 34 and then secured using single layer collar covered by butt collar 46. Once butt collar 40 is positioned about the abutting ends of grease-duct wrap sections 10 and 10A, it is secured to wrap sections 10 and 10A using steel banding 6 which also secures the wrap sections to the duct.

In each case, overlap or butt collar overlap, steel banding 6, in this example, is wrapped completely about wrapped duct 100 every 6″ on center to assure that the duct is completely insulated to provide a one-layer, one-hour tested and rated protection for grease ducts. The need for only one layer of wrap according to the present invention, as compared to the two layers required by presently available grease-duct wraps cuts installation time by 50 percent, thus providing the highest quality of fire protection insulation at one-half of the installation cost. Moreover, the tested and rated protection provided by the grease-duct wrap of the present invention provides for zero clearance to combustible material, such as wooden beams. This is of utmost importance as there is usually a 3 inch, or less, gap between the grease-duct and the combustible wooden trusses of the building.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is,:

1. A single-layer duct wrap, comprising:
a sequence of sheets comprising;
two fiber insulation-blanket sheets;
one metal foil sheet, and
a laminate sheet,
said metal foil sheet sandwiched between said two of fiber insulation-blanket sheets,
said laminate sheet encasing and sealing using metal foil tape said sequence of sheets within itself forming a single-layer duct wrap.

2. The single-layer duct wrap, as recited in claim 1, wherein said laminate sheet comprises a three-ply laminate sheet.

3. The single-layer duct wrap, as recited in claim 1, wherein said three-ply laminate sheet comprises:
an aluminum foil backing ply;
a fiberglass scrim ply, and
an aluminized polyester face ply,
said fiberglass scrim ply between said aluminum foil backing ply and said aluminized polyester face ply.

4. The single-layer duct wrap, as recited in claim 1, wherein said metal foil sheet comprises an aluminum sheet or stainless steel foil sheet.

5. The single-layer duct wrap, as recited in claim 1, wherein said single-layer duct wrap has a total thickness of about 1-2 inches.

6. The single-layer duct wrap, as recited in claim 1, wherein said single-layer duct wrap has the property of a zero clearance to combustible.

7. The single-layer duct wrap, as recited in claim 1, said single-layer duct wrap further having a one, two or three hours fire-resistant rating.

8. The single-layer duct wrap, as recited in claim 1, further including banding, said banding securing said single-layer duct wrap to a duct when wrapped completely said duct every six inches on center.

9. The single-layer duct wrap, as recited in claim 8, wherein said banding is ½ inch wide steel banding.

10. A single-layer duct wrap, comprising:
a sequence of sheets comprising;
two fiber insulation-blanket sheets;
two metal foil sheets, and
a protective cloth or an intumescent mat sheet,
a laminate sheet,
said protective cloth or intumescent mat sheet sandwiched between said two foil sheets forming an inner sheet sequence,
said inner sheet sequence sandwiched between said two fiber insulation-blanket sheets,
said three-ply laminate sheet encasing and sealing using metal foil tape said sequence of sheets within itself forming a single-layer duct wrap.

11. The single-layer duct wrap, as recited in claim 10, wherein said laminate sheet comprises a three-ply laminate sheet.

12. The single-layer duct wrap, as recited in claim 10, wherein said three-ply laminate sheet comprises:
an aluminum foil backing ply;
a fiberglass scrim ply, and
an aluminized polyester face ply,
said fiberglass scrim ply between said aluminum foil backing ply and said aluminized polyester face ply.

13. The single-layer duct wrap, as recited in claim 10, wherein said metal foil sheet comprises an aluminum sheet or stainless steel foil sheet.

14. The single-layer duct wrap, as recited in claim 10, wherein said single-layer duct wrap has a total thickness of about 1-2 inches.

16. The single-layer duct wrap, as recited in claim 10, further including banding, said banding securing said single-layer duct wrap to a duct.

17. The single-layer duct wrap, as recited in claim 10, said single-layer duct wrap further having a one, two or three hours fire-resistant rating.

18. A single-layer duct wrap, comprising:
a sequence of sheets comprising;
two fiber insulation-blanket sheets;
one aluminum sheet or stainless steel foil sheet, and
a laminate sheet comprising:
an aluminum foil backing ply;
a fiberglass scrim ply, and
an aluminized polyester face ply,
said fiberglass scrim ply between said aluminum foil backing ply and said aluminized polyester face ply,
said foil sheet sandwiched between said two fiber insulation-blanket sheets,
said laminate sheet encasing and sealing using metal foil tape said sequence of sheets within itself forming a single-layer duct wrap.

19. A single-layer duct wrap, as recited in claim 19, wherein said sequence of sheets comprises an additional:
aluminum or stainless steel foil sheet, and
a protective cloth or an intumescent mat sheet,
said protective cloth or intumescent mat sheet sandwiched between said two aluminum or stainless steel foil sheets forming an inner-sheet sequence,
said inner-sheet sequence sandwiched between said two fiber insulation-blanket sheets,
said laminate sheet encasing and sealing using metal foil tape said sequence of sheets within itself forming a single-layer duct wrap.

20. The single-layer duct wrap, as recited in claim 18, wherein said single-layer duct wrap has a one, two or three hours fire-resistant rating with a total thickness of about 1-2 inches.
